(19) United States
(12) Patent Application Publication
(10) Pub. No.: US 2008/0137658 A1
(43) Pub. Date: Jun. 12, 2008

(54) APPARATUS AND METHOD FOR COMPUTER MANAGEMENT

(75) Inventor: Tsung-Pin Wang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INVENTEC CORPORATION, Taipei City (TW)

(21) Appl. No.: 11/624,218

(22) Filed: Jan. 18, 2007

(30) Foreign Application Priority Data
Dec. 6, 2006 (TW) 95145377

(51) Int. Cl. H04L 12/56

(52) U.S. Cl. 370/392; 370/401

(57) ABSTRACT

An apparatus and a method for computer management are provided. In the present invention, the baseboard management controllers (BMCs) of a plurality of baseboards are connected through a network. A broadcasting packet is sent to each BMC by switching a virtual local area network (VLAN) so as to obtain a default Internet protocol address (IP address) and a media access control address (MAC address) of each BMC and reset the IP addresses of the BMCs with particular IP addresses. Therefore, in a subsequent management function, a control instruction can be sent to each BMC directly for controlling the BMCs to execute particular functions.

### CROSS-REFERENCE TO RELATED APPLICATION

This application claims the priority benefit of Taiwan application serial no. 95145377, filed Dec. 6, 2006. All disclosure of the Taiwan application is incorporated herein by reference.

### BACKGROUND OF THE INVENTION

1. Field of the Invention

The present invention relates to an apparatus and a method for computer management, and more particularly to a computer management apparatus and method for managing a plurality of baseboards by connecting the baseboards of a super computer through a network.

2. Description of Related Art

With the rapid advance in computer technology, the computing power of microprocessors grow rapidly so that the computing speed of a computer is getting faster while the cost is getting lower. At the present time, almost all personal computers have the power to deal with ordinary word processing and computing jobs. However, jobs that demand lots of computation still require a special arrangement. “Cluster computer” is a name given to a super system capable of linking together a large number of computers into a highly reliable and computationally powerful device. By utilizing the combined power of the computers to accelerate the speed of a computing job, the computational requirements of virtually any kind of application programs are satisfied.

However, this kind of super computer has a high price tag. In general, the cost of building a super computer is high and a huge room is needed to house all the equipment. With the techniques for building more powerful and yet miniaturized processors, a personal super computer with a relatively low production cost and high operational speed has been developed in recent years. By inserting a few baseboards in the housing of a computer and utilizing a plurality of core processors in these baseboards to increase operational performance, several hundreds of million floating point operations per second (megaflops) to thousands of million floating point operations per second (gigaflops) can be executed. Although this speed is still in a grade level away from a super computer, it is already tens of thousand times faster than most personal computers.

Nevertheless, the method of inserting a plurality of baseboards in the housing will increase the overall “weight” of the system. Therefore, how to increase the operational performance of a computer while considering conditions such as the noise level, the power consumption, and the amount of heat produced in operation so that the user can operate in an office environment is also part of the criteria for reviewing the performance of a personal supercomputer.

To monitor the operation of each device on each baseboard, the baseboard manufacturers have developed a baseboard management controller (BMC). A chip is embedded on the baseboard to serve as a central processor for the hardware platform management. The baseboard management controller can be electrically connected to a built-in sensing device and chip of the baseboard through an intelligent platform management bus (IPMB) so as to monitor and manage the performance of the computer accordingly.

FIG. 1 is a block diagram of a conventional personal super computer. As shown in FIG. 1, the personal super computer 100 includes a substrate 110 having four baseboards 120˜150 plugged therein. The power source, IPMB, system management bus (SM bus) and network interface of the baseboards 120˜150 are connected to the substrate 110 and managed by the substrate 110. The substrate 110 can control the baseboard management controllers through the IPMB and execute a controlling function. Moreover, through the monitored data returned from the baseboard management controllers, the operation of devices such as the fan 160 and the power switch 170 can be properly managed.

However, a connection through the IPMB or the system management bus not only results in a slower transmission speed, but also prevents a direct communication with the outside world. Hence, users cannot connect with each baseboard in the computer through a network connection, which is a significant disadvantage.

### SUMMARY OF THE INVENTION

Accordingly, the present invention is directed to a computer management apparatus. By setting a virtual local area network (VLAN) in a switching unit and using a process unit to switch the VLAN through the switching unit, Internet protocol (IP) addresses of the baseboard management controllers of a plurality of baseboards are obtained and set for managing computer performance.

The present invention is also directed to a computer management method. By sending a broadcasting packet to the baseboard management controller (BMC) of each baseboard, IP addresses of the baseboard management controllers are obtained and set. Then, control instructions are received through the network and the control instructions are accordingly used for controlling the baseboard management controllers to execute functions so as to achieve remote management.

To achieve these and other advantages, as embodied and broadly described herein, the invention provides a computer management apparatus including a switching unit and a processing unit. The switching unit has a first connection port and a plurality of second connection ports and is suitable for setting a virtual local area network for each of the second connection ports. Each second connection port is used for connecting to a baseboard management controller of a baseboard. The processing unit is connected to the switching unit through the first connection port and suitable for sending a broadcasting packet to each baseboard management controller through the virtual local area network set by the switching unit so that the default Internet protocol address of each baseboard management controller is set to a particular Internet protocol address. According to the particular Internet protocol address, a control instruction is submitted to the baseboard management controller for controlling the baseboard management controller to execute the required functions.

According to the computer management apparatus in the preferred embodiment of the present invention, each second connection port further includes a detection pin for detecting whether the second connection port is connected to the baseboard. The second connection ports further include connecting to the network connecting ports of the baseboard management controllers.

According to the computer management apparatus in the preferred embodiment of the present invention, the processing unit further includes a third connection port for connecting to the network. The processing unit is suitable for receiving control instructions from the network through the third connection port.

According to the computer management apparatus in the preferred embodiment of the present invention, the first connection port, the second connection port and the third connection port are network connection ports.

According to the computer management apparatus in the preferred embodiment of the present invention, the function executed by the baseboard management controllers includes monitoring the baseboard to obtain monitored data. The monitored data includes temperature and rotating speed of fan.

According to the computer management apparatus in the preferred embodiment of the present invention, the monitored data is returned to the processing unit after each baseboard management controller has obtained monitored data. The processing unit is connected to a plurality of external devices. The operations of these external devices are managed according to the monitored data returned from the baseboard management controllers. The external devices include either a fan or a power switch.

According to the computer management apparatus in the preferred embodiment of the present invention, the broadcasting packet includes a virtual local area network (VLAN) tag. The switching unit switches the VLAN according to the VLAN tag so that broadcasting packet is sent to the baseboard management controller through the connection port corresponding to the VLAN tag. The foregoing broadcasting packet is an address resolution protocol (ARP) packet.

The present invention also provide a computer management method including the following steps. First, connection with one or more baseboard is detected. When the connection with a baseboard is detected, a broadcasting packet is sent to the baseboard management controller of each baseboard so that the default Internet protocol address of each baseboard management controller is set to a particular Internet protocol address. Finally, according to the particular Internet protocol addresses, a control instruction is sent to each baseboard management controller for controlling the baseboard management controllers to execute the required functions.

According to the computer management method in the preferred embodiment of the present invention, before sending the broadcasting packet to each baseboard management controller, the virtual local area network (VLAN) is further set according to the connection port of each baseboard management controller. Furthermore, the step of sending the broadcasting packet to each baseboard management controller includes switching the VLAN according to a VLAN tag in the broadcasting packet and sending the broadcasting packet to the baseboard management controller through the connection port corresponding to the VLAN tag.

According to the computer management method in the preferred embodiment of the present invention, the step of sending the broadcasting packet to each baseboard management controller and setting the default Internet protocol address of each baseboard management controller to the particular Internet protocol address includes sending the broadcasting packet to the baseboard management controllers. Then, each baseboard management controller returns its default Internet protocol address and media access control address (MAC address). Thereafter, the default Internet protocol address returned from each baseboard management controller is checked to determine if it is identical to the particular Internet protocol address. If the two Internet protocol addresses are identical, the default Internet protocol address of the baseboard management controller remains as it is. Conversely, if the two Internet protocol addresses are different, the default Internet protocol address of the baseboard management controller is changed to the particular Internet protocol address.

According to the computer management method in the preferred embodiment of the present invention, before sending the control instruction to the baseboard management controller according to the particular Internet protocol address for controlling the baseboard management controllers to execute the required functions, further includes connecting to the network, receiving the control instructions through the network and sending the received control instructions to the baseboard management controllers.

According to the computer management method in the preferred embodiment of the present invention, the method further includes receiving the monitored data from each baseboard management controller and managing the operations of a plurality of external devices according to the monitored data returned from the baseboard management controllers.

In the present invention, the baseboard management controllers of a plurality of baseboards are connected through a network. Then, a broadcasting packet is sent to each baseboard management controller by switching a virtual local area network so as to obtain a default Internet protocol address and a media access control address of each baseboard management controller and reset the IP addresses of the baseboard management controllers with particular IP addresses. Therefore, in a subsequent management function, a control instruction can be sent to each baseboard management controller directly for controlling the baseboard management controllers to execute particular functions.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional personal super computer.

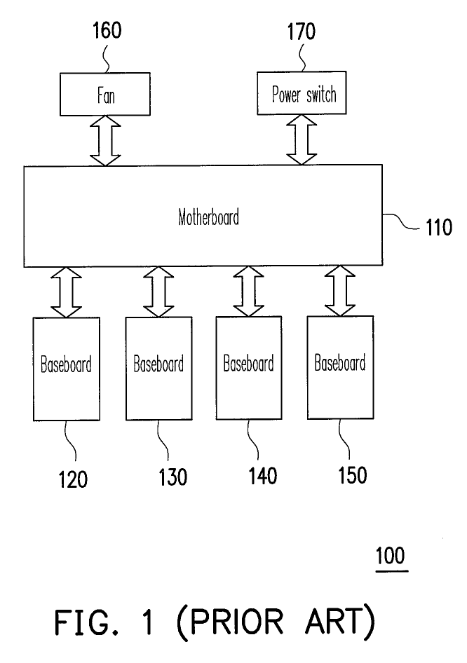

FIG. 2 is a block diagram of a computer management apparatus according to a preferred embodiment of the present invention.

FIG. 3 is a flow diagram showing a computer management method according to a preferred embodiment of the present invention.

FIG. 4 is a flow diagram showing a method for setting the Internet protocol address according to a preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The local area network channel (LAN channel) in a baseboard management controller provides pipeline for connecting with a local area, such that the baseboard management controller can transmit message through the local area network. Accordingly, by establishing a switching unit in a computer management module for serially connecting the baseboard management controller of each baseboard in a personal super computer, instructions can be simultaneously delivered to all the baseboard management controllers to obtain monitored data. To provide a clearer description of the present invention, an actual embodiment is given below as an example to show the feasibility of the present invention.

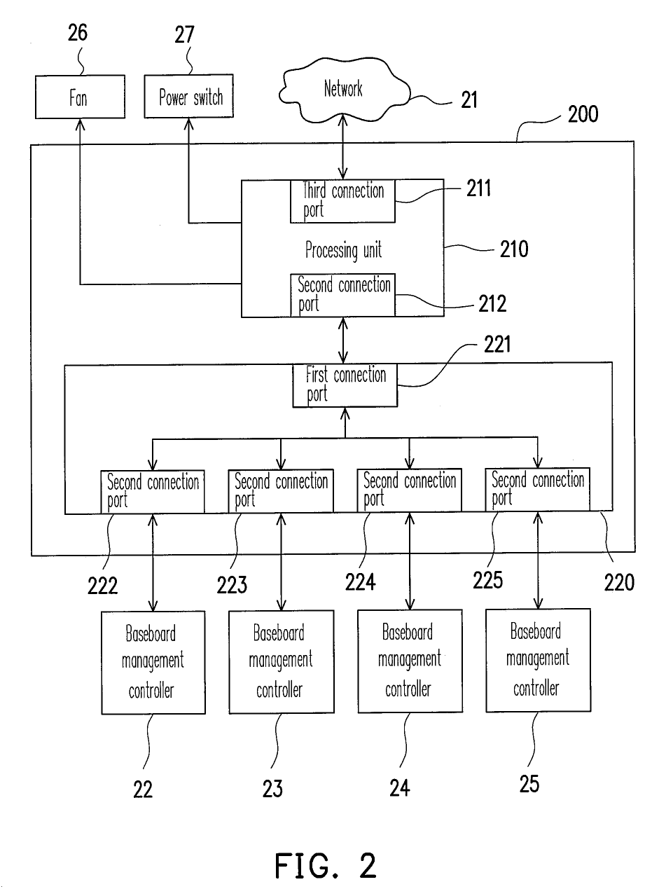

FIG. 2 is a block diagram of a computer management apparatus according to a preferred embodiment of the present invention. As shown in FIG. 2, the computer management apparatus 200 in the present embodiment includes a processing unit 210 and a switching unit 220. The processing unit 210 and the switching unit 220 are connected using first connection ports 212 and 221. In addition, the processing unit 210 further includes a third connection port 211 for connecting to the network 21, a connection to a fan 26 and a connection to a power switch 27. The switching unit 220 includes a plurality of second connection ports 222˜225 for connecting to the baseboard management controller (BMC) 22˜25 of a plurality of baseboards (not shown). Furthermore, the first connection ports 212, 221, the second connection ports 222˜225 and the third connection port 211 are network connection ports, for example, but their scope is not limited in this way.

The switching unit 220 sets a virtual local area network (VLAN) for the second connection ports 222˜225 disposed therein. The virtual local area network is used for performing a logical segmentation for those baseboard management controllers connected to the switching unit 220 without being limited by the physical locations of the baseboard management controllers. Because the data or packet sent by the members of the VLAN can only be transmitted between members of the VLAN, they cannot be sent outside the network. Therefore, the transmitted data are restricted within the network and prevented from affecting other network segment. More simply, the switching unit 220 is able to learn and memorize the Internet protocol address (IP address) or media access control address (MAC address) of its connected devices. According to these addresses, the packets can be filtered to improve the transmission efficiency between each of the devices.

The processing unit 210 is capable of sending a broadcasting packet to the switching unit 220 through its connection with the switching unit 220. The broadcasting packet includes, for example, a virtual local area network (VLAN) tag and the switching unit 220 decodes this VLAN tag after receiving the broadcasting packet. According to the decoded VLAN tag, the VLAN is switched and the broadcasting packet is re-transmitted to the baseboard through a connection port corresponding to the VLAN tag.

The broadcasting packet sent to the baseboard is, for example, an address resolution protocol (ARP) packet, which is a part of a transmission control protocol/Internet protocol (TCP/IP) member, and is mainly used for resolving IP address or hardware address corresponding to a host name so as to achieve a data transmission function. By sending the broadcasting packet, the processing unit 210 is able to obtain default Internet protocol address (default IP address) and media access control address (MAC address) of each baseboard (in other words, the baseboard management controller of the baseboard). Next, the Internet protocol address of each baseboard is set to a particular Internet protocol address.

Thereafter, if there is a need to obtain data from the baseboard management controllers 22˜25, control instructions can be transmitted to the baseboard management controllers 22˜25 according to the particular Internet protocol addresses for controlling the baseboard management controller 22˜25 to execute the required functions. The control instruction is, for example, obtained by the processing unit 210 from the network 21 through the third connection port 211.

It should be noted that a detection pin is also disposed among the second connection ports 222˜225 for detecting the presence of any baseboard connection so that the broadcasting packet is sent only to those baseboard management controllers 22˜25 of the connected baseboards.

In addition, the control instruction from the processing unit 210 is, for example, a monitoring instruction for controlling the baseboard management controllers 22˜25 to monitor the baseboards and obtain monitored data such as temperature or fan speed. After the baseboard management controllers 22˜25 have finished their monitoring operations, the monitored data is returned to the processing unit 210. Through the monitored data, the processing unit 210 is able to manage the operation of the fan 26 and the power switch 27.

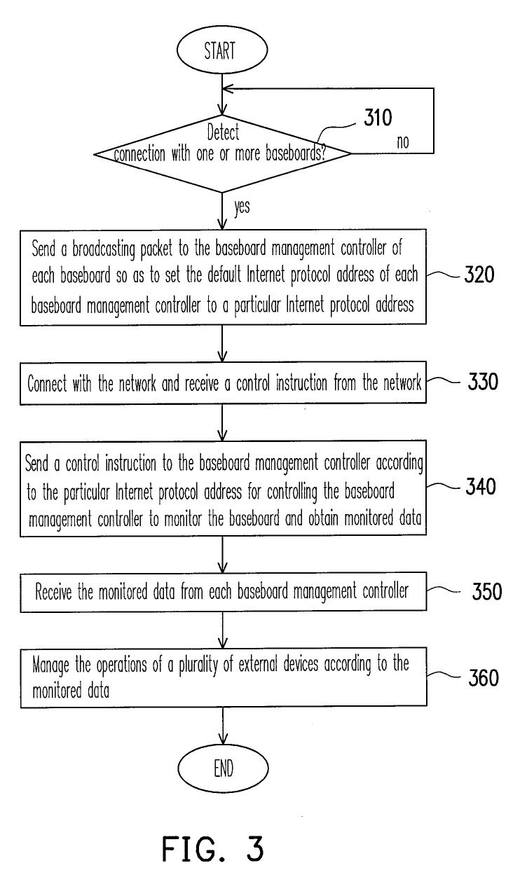

To provide a clearer description of the operation between the devices in the computer management apparatus, another embodiment is given below to show the steps in the computer management method of the present invention. FIG. 3 is a flow diagram showing a computer management method according to a preferred embodiment of the present invention. As shown in FIG. 3, the present embodiment is suitable for utilizing a network connection to control the baseboard management controllers of a plurality of baseboards so that the baseboard management controllers can execute monitoring functions. According to the monitored data returned from the baseboard management controllers, the operation of devices such as a fan and a power switch are managed.

First, connection with one or more baseboards is detected (step S310). The method of detecting the baseboards includes, for example, disposing an input/output (I/O) pin on the connection port of the motherboard corresponding to connecting with each baseboard. Thus, when a baseboard is plugged, connection with the baseboard is immediately detected. Here, the so-called connection may include the baseboard power source, data bus, peripheral devices, network cards and baseboard management controllers, and there is no particular restriction on the type of connections. Obviously, as in the previous embodiment, the most important aspect of the present invention is the connection with the baseboard management controllers.

When one or more baseboard connections are detected, a broadcasting packet is sent to the baseboard management controller of each baseboard for setting the default Internet protocol addresses of these baseboard management controllers to particular Internet protocol addresses (step S320). Conversely, if connection to the baseboard is not detected, then the detection process is continued.

Before sending the broadcasting packet to the baseboard management controllers, a virtual local area network (VLAN) with respect to the connection ports of the baseboard management controllers may first be established. When the broadcasting packet is sent and the Internet protocol address is set in practice, the broadcasting packet can be selectively sent to a corresponding baseboard management controller for setting the Internet protocol address according to a VLAN tag in the broadcasting packet.

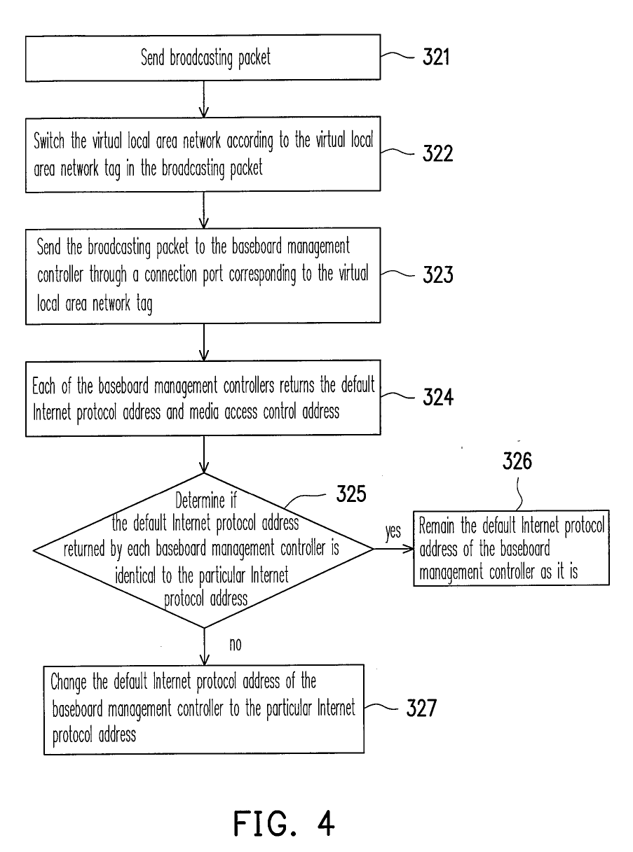

FIG. 4 is a flow diagram showing a method for setting the Internet protocol address according to a preferred embodiment of the present invention. As shown in FIG. 4, the present embodiment first sends out a broadcasting packet (step S321). Then, according to a VLAN tag in the broadcasting packet, the VLAN is switched (step S322) so as to send the broadcasting packet to a baseboard management controller through a connection port corresponding to the VLAN tag (step S323). The broadcasting packet is, for example, an address resolution protocol (ARP) packet for obtaining the default Internet protocol address or media access control address of each baseboard management controller.

After a baseboard management controller has received a broadcasting packet, the baseboard management controller returns its default Internet protocol address and media access control address (step S324). Therefore, the next step is to check whether the default Internet protocol address returned by each baseboard controller is identical to the particular Internet protocol address (S325). If they are identical, then there is no need to change the default Internet protocol address of the baseboard management controller (S325). Conversely, if they are different, the default Internet protocol address of the baseboard management controller is changed to the particular Internet protocol address.

For example, as shown in FIG. 2, assume the particular Internet protocol addresses set by the switching unit 220 with respect to the second connection ports 222˜225 are 192.168.0.1, 192.168.0.2, 192.168.0.3 and 192.168.0.4, respectively, and the default Internet protocol address of the baseboard management controllers 22˜25 is set to 192.168.0.1. Therefore, when the baseboard management controller 22 is connected to the second connection port 222, the processing unit 210 will send a broadcasting packet to the baseboard management controller 22 and the baseboard management controller 22 will return its default Internet protocol address 192.168.0.1. Since the default Internet protocol address returned by the baseboard management controller 22 is accidentally identical to the originally set particular Internet protocol address of the second connection port 222 (that is, 192.168.0.1), there is no need to change the default Internet protocol address of the baseboard management controller 22. On the other hand, when the baseboard management controller 23 is connected to the second connection port 223, the processing unit 210 will similarly send a broadcasting packet to the baseboard management controller 23 and the baseboard management controller 23 will return its default Internet protocol address 192.168.0.1. However, the default Internet protocol address (192.168.0.1) is now different from the originally set particular Internet protocol address (192.168.0.2) of the second connection port 223. Hence, the default Internet protocol address must be changed to 192.168.0.2 so that the processing unit 210, when subsequently managing the baseboard management controller 23, can correctly transmit control instructions to the baseboard management controller 23 through the particular Internet protocol address. Similarly, the method of setting the baseboard management controllers 24 and 25 is identical or similar to the one mentioned above, and therefore the detailed description is omitted here.

Back to step S320, the present embodiment further includes connecting to the network after setting the default Internet protocol addresses of the baseboard management controllers so that control instructions can be received from a remote location via the network (step S330). Accordingly, a user can use a remote computer to send control instructions to the computer management apparatus of the present invention so as to control the baseboard management controller of each baseboard for executing the desired functions. Obviously, the user can also transmit control instructions through the local end of a computer and there are no particular restrictions on this in the present invention.

In the next step, the control instructions are sent to each baseboard management controller according to the previously set particular Internet protocol addresses so as to control the baseboard management controllers to execute monitoring functions and obtain monitored data (step S340). The monitored data includes, for example, temperature of fan speed, but is not restricted as such.

Finally, the monitored data is received through these baseboard management controllers (step S350). According to the monitored data, the operations of external devices such as a fan or a power switch are managed (step S360).

Through the foregoing computer management method, no matter which baseboard of a personal super computer is plugged into whatever connection port, its default Internet protocol address can be detected and modified if necessary, and then accordingly, used for controlling the baseboard management controllers to execute the desired functions. In addition, the user can send control instructions from a remote terminal through the network to the computer management apparatus. The computer management apparatus then organizes the returned data from the baseboard management controllers of the baseboards and uses them for managing the computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer management apparatus, comprising:
a switching unit having a first connection port and a plurality of second connection ports, and suitable for establishing a virtual local area network with respect to the second connection ports, wherein each second connection port is used for connecting to a baseboard management controller of a baseboard; and
a processing unit, connected to the switching unit through the first connection port, and suitable for sending a broadcasting packet to the baseboard management controllers through the virtual local area network set up by the switching unit so that a default Internet protocol address of each of the baseboard management controllers is set to a particular Internet protocol address, and according to the particular Internet protocol address, a control instruction is sent to the baseboard management controllers for controlling the baseboard network controllers to execute an function.

2. The computer management apparatus of claim 1, wherein the switching unit further comprises a detection pin corresponding to each of the second connection ports for detecting whether the baseboard is connected.

3. The computer management apparatus of claim 1, wherein each of the second connection ports comprises a network connection port connected to the baseboard management controller.

4. The computer management apparatus of claim 1, wherein the processing unit further comprises:
a third connection port for connecting to a network, wherein the processing unit is suitable for receiving the control instruction transmitted via the network through the third connection port.

5. The computer management apparatus of claim 4, wherein the first connection port, the second connection ports and the third connection port comprise network connection ports.

6. The computer management apparatus of claim 1, wherein the function comprises monitoring the baseboard to obtain a monitored data.

7. The computer management apparatus of claim 6, wherein the monitored data comprises temperature and fan speed.

8. The computer management apparatus of claim 6, wherein the monitored data are returned to the processing unit after each of the baseboard management controllers has obtained the monitored data.

9. The computer management apparatus of claim 8, wherein the processing unit is connected to a plurality of external devices and the operations of these external devices are managed according to the monitored data returned by the baseboard management controllers.

10. The computer management apparatus of claim 9, wherein the external devices comprise a fan or a power switch.

11. The computer management apparatus of claim 1, wherein the broadcasting packet comprises a virtual local area network tag, and the switching unit switches the virtual local area network according to the virtual local area network tag and sends the broadcasting packet to the baseboard management controller through the connection port corresponding to the virtual local area network tag.

12. The computer management apparatus of claim 1, wherein the broadcasting packet comprises an address resolution protocol (ARP) packet.

13. A computer management method, comprising the following steps:
detecting whether one or more baseboards are connected;
sending a broadcasting packet to a baseboard management controller of each of the baseboards when the baseboard is detected to be connected, so as to set a default Internet protocol address of each of the baseboard management controllers to a particular Internet protocol address; and
sending a control instruction to the baseboard management controllers according to the particular Internet protocol addresses for controlling the baseboard management controllers to execute an function.

14. The computer management method of claim 13, wherein, before sending the broadcasting packet to each of the baseboard management controllers, further comprising:
setting a virtual local area network with respect to the plurality of connection ports connected to the baseboard management controllers.

15. The computer management method of claim 14, wherein the step of sending the broadcasting packet to each of the baseboard management controllers comprising:
switching the virtual local area network according to a virtual local area network tag in the broadcasting packet; and
sending the broadcasting packet to the baseboard management controller through the connection port corresponding to the virtual local area network tag.

16. The computer management method of claim 13, wherein the step of sending the broadcasting packet to each of the baseboard management controllers so that the default Internet protocol address of each of the baseboard management controller is set to the particular Internet protocol address comprising:
sending the broadcasting packet to the baseboard management controllers;
each of the baseboard management controller returning the default Internet protocol address and a media access control address;
determining if the default Internet protocol address returned by each of the baseboard management controllers is identical to the particular Internet protocol address;
if they are identical, then the default Internet protocol address of the baseboard management controller remains as it is; and
if they are different, then the default Internet protocol address of the baseboard management controller is changed to the particular Internet protocol address.

17. The computer management method of claim 13, wherein before sending the control instruction to the baseboard management controller according to the particular Internet protocol address for controlling the baseboard management controller to execute the function, further comprising:
connecting to a network;
receiving the control instruction via the network; and
sending the received control instructions to the baseboard management controllers.

18. The computer management method of claim 13, wherein the function executed by the baseboard management controller comprises monitoring the baseboard to obtain a monitored data.

19. The computer management method of claim 18, wherein the monitored data comprises temperature and fan speed.

20. The computer management method of claim 18, further comprising:
receiving the monitored data returned by each of the baseboard management controllers; and
managing the operations of a plurality of external devices according to the monitored data returned by the baseboard management controllers.

21. The computer management method of claim 20, wherein the external devices comprise fans or power switches.

22. The computer management method of claim 13, wherein the broadcasting packet comprises an address resolution protocol (ARP) packet.
